(19) United States
(12) Patent Application Publication
(10) Pub. No.: US 2015/0163477 A1
(43) Pub. Date: Jun. 11, 2015

(54) SYSTEMS AND METHODS FOR CALCULATING EPIPOLAR CONSTRAINTS BETWEEN GENERALIZED CAMERAS

(71) Applicants: Bryan Klingner, Oakland, CA (US); David Martin, Mountain View, CA (US); Scott Ettinger, Mountain View, CA (US)

(72) Inventors: Bryan Klingner, Oakland, CA (US); David Martin, Mountain View, CA (US); Scott Ettinger, Mountain View, CA (US)

(73) Assignee: Google Inc., Mountain View, CA (US)

(21) Appl. No.: 13/372,559

(22) Filed: Feb. 14, 2012

(51) Int. Cl. H04N 13/02; H04N 5/353; G06T 15/20

(52) U.S. Cl. CPC H04N 13/0239; G06T 15/20; H04N 5/353

(57) ABSTRACT

Methods and systems for calculating epipolar constraints between a plurality of generalized cameras are provided. Each generalized camera implements two pixel projection functions. One function converts a known pixel location into a ray emanating from a projection center of a first camera to a point on a feature at the pixel location. Another function converts a three dimensional point on the feature in Euclidean space to a pixel location on a projection of the feature in the image space of a second camera. Subsegments of along the ray are projected onto the image space of the second camera and are subdivided until each subsegment spans no more than one pixel in the second camera's image space. The endpoints of all subsegments are projected into the image space of the second camera and the discrete pixel locations of each subsegment are recorded to form epipolar zones.

### BACKGROUND

1. Statement of the Technical Field

Embodiments include systems and methods for calculating epipolar constraints between generalized cameras.

2. Description of the Related Art

Computer vision is a scientific and technological field that seeks to develop methods for acquiring, processing, analyzing, and understanding images. Specifically, computer vision practitioners seek to develop theories and models designed to extract information about a three dimensional scene from one or more two dimensional images of the scene captured by one or more cameras. Applying these models, it is possible to reconstruct an approximation of the three dimensional space from the two dimensional images.

Epipolar geometry is a mathematical field that analyzes stereoscopic imagery. The mathematics of epipolar geometry describe relationships between three dimensional points in Euclidean space and two dimensional points, i.e. pixel locations, projected on a two dimensional image space. These relationships are described through epipolar constraints that require each point in a first image from a first camera to correspond a set of points along a known epipolar line in a second image from a second camera.

Specifically, epipolar geometry describes the relationship between the image spaces of two idealized, linear pinhole cameras. An idealized pinhole camera model describes the mathematical relationships between a point in Euclidean space and its projection onto the image space of an ideal pinhole camera. The pinhole camera model describes the camera aperture as a point in Euclidean space and does not include lenses for focusing light. As a result, the model does not include lens distortion effects or object blurring.

Notwithstanding the shortcomings of the pinhole camera model listed above, it is still used as a first order approximation of a three dimensional scene in a two dimensional image space. Conversely, many conventional non-linear cameras which maintain a single center of projection may be mapped to a linear approximation using the pinhole camera model, thereby allowing for fast mapping between the three dimensional scene and its two dimensional projection in the camera's image space.

However, this “linearization” only works with a camera where each pixel of the camera's image space shares a single center of projection. This technique does not work with a generalized camera where pixels do not share the same center of projection. For example, a rolling shutter camera acquires an image by scanning across the entire image frame, i.e. different pixels are not acquired at the same time. Fast moving objects or camera motion may cause distortions that cannot be approximated using a liner camera model.

Therefore, it would be desirable to develop a system and method capable of describing relationships between a non-linear generalized camera image space of non-linear generalized cameras and a three dimensional scene, similar to epipolar constraints of the pinhole cameral model.

### SUMMARY OF THE INVENTION

Methods and systems for calculating epipolar constraints between a plurality of generalized cameras are provided. Each generalized camera implements two pixel projection functions that allow for immediate conversion between a two dimensional pixel location, and a three dimensional world point location. One function converts a known pixel location into a ray emanating from a camera center of a first camera to a point on a feature at the pixel location. Another function converts a three dimensional point on the feature in Euclidean space to a pixel location on a projection of the feature in the image space of a second camera. Segments of the ray are projected onto the image space of the second camera and are subdivided until each subsegment spans no more than one pixel in the second camera's image space. The pixel span may be computed by projecting the pixel span's end points and measuring the distance between them on the second camera's image space. The endpoints of all subsegments are projected into the image space of the second camera and the discrete pixel locations of each subsegment are recorded. The collection of pixel locations defines an epipolar zone of the feature in the second camera's image space that identifies which pixels in the image space may contain a view of the feature.

In implementations, the provided method may be accelerated. In one implementation, the resolution of the epipolar zone may be adjusted by changing the pixel size in the image space of the second camera. For example, coarsening the pixel resolution may speed computation in applications at the expense of accuracy. In another implementation, the midpoint of a subsegment is projected into the image space of the second camera, in to addition its endpoints. If the subsegment is sufficiently linear, then the projected subsegment may be directly rasterized into the image space of the second camera without further projection or division of the subsegment.

In another implementation, the initial subsegment of the ray to be subdivided and projected into the image space of second camera may be determined by intersecting the ray with geometric representation of the field of view of second camera. For example, if field of view of second camera is approximated by a cone, then the segment endpoints may be calculated by the intersection of the ray and the cone.

In another implementation, assuming accuracy is reduced by the used of one of the above alternate implementations, the final result may be morphologically dilated to recover a zone that contains the true epipolar zone.

### BRIEF DESCRIPTION OF THE DRAWINGS

Embodiments will be described with reference to the following drawing figures, in which like numerals represent like items throughout the figures, and in which:

FIG. 1 is a block diagram of an generalized camera system.

FIGS. 2A-B are diagrams of the image spaces of two generalized cameras.

FIG. 3 is a flow diagram of an exemplary method for use in a device with an electronic circuit.

FIG. 4 is a flow diagram of an exemplary method for use in a device with an electronic circuit.

### DETAILED DESCRIPTION

Example implementations of the present invention are described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

The phrase “structure from motion” (SFM) is used herein to mean the process of computing three dimensional geometry from multiple images of a scene.

A “generalized camera” is used herein to mean a camera where different pixels do not share the same center of projection. Generalized cameras may arise from exotic optics (e.g. catadioptric optical systems) as well as from rolling shutter cameras in motion.

A “rolling shutter camera” is used herein to mean one where the pixels of an image are exposed not at a single time T but according to some function T(x,y) that varies according to the image position (x,y). For example, a simple rolling shutter function is T(x, y)=a+b*x, where a and b are constants, so that each column is exposed sequentially across the image frame. In contrast, an “instantaneous shutter camera” exposes all pixels at approximately the same time, e.g. T(x, y)=a, where a is a constant.

The phrase “lens distortion” as used herein denotes how light rays deviate from a pinhole projection model as they pass through the lens system of a camera.

The word “feature” as used herein denotes a distinctive subset of an image that can be programmatically detected. Features are often used to identify identical parts of a scene viewed from multiple cameras.

“Epipolar geometry” as used herein refers to the relative geometry of two idealized, linear, pinhole cameras, i.e. how they are arranged in space with respect to each other and hence how the image space of one camera is mapped into another.

“Epipolar line” as used herein denotes a line segment in the image space of one linear perspective camera that corresponds to the projection of a ray through the optical center of another camera. Epipolar lines may be used in SFM to aid in feature matching because epipolar lines identify a subset of an image in one camera that could correspond to a feature in the other camera.

Embodiments advantageously provide systems and methods of calculating epipolar constraints between a plurality of generalized cameras. Each generalized camera implements two pixel projection functions that allow for immediate conversion between a two dimensional pixel location, (u,v) and a three dimensional world point location (x,y,z). One function converts a known pixel location (u,v) into a ray r(nₓ,n_{y},n_{z}) through a function pixel_to_world_ray(C,u,v). Another function converts a three dimensional world point (x,y,z) to a pixel location (u,v) through a function world_point_to_pixel(C,x,y,z). In both functions, C is a generalized camera model. In an implementation, two generalized cameras, C₁ and C₂ each generate a two dimensional image of a feature f₁. Using a function pixel_to_world_ray(C₁,u₁,v₁), a ray r(nₓ,n_{y},n_{z}) is computed emanating from the camera center of C₁ and passing through the feature at (u₁,v₁). Subsegments of r are computed by sampling points (xᵢ,yᵢ,zᵢ) along r to be used as inputs into a function world_point_to_pixel(C₂,xᵢ,yᵢ,zᵢ). If any non-empty intersections exist, continue dividing subsegments further until each subsegment spans no more than one pixel in C₂'s image space. The pixel span may be computed using the world_point_to_pixel function to find the projection of the subsegments's end points and measuring the distance between them. The endpoints of all subsegments are projected into the image space of C₂ using the world_point_to_pixel function and the discrete pixel locations of each subsegment are recorded. The collection of pixel locations defines an epipolar zone of feature f₁ in C₂. The epipolar zone identifies which pixels in the image space of C₂ contain a view of f₁.

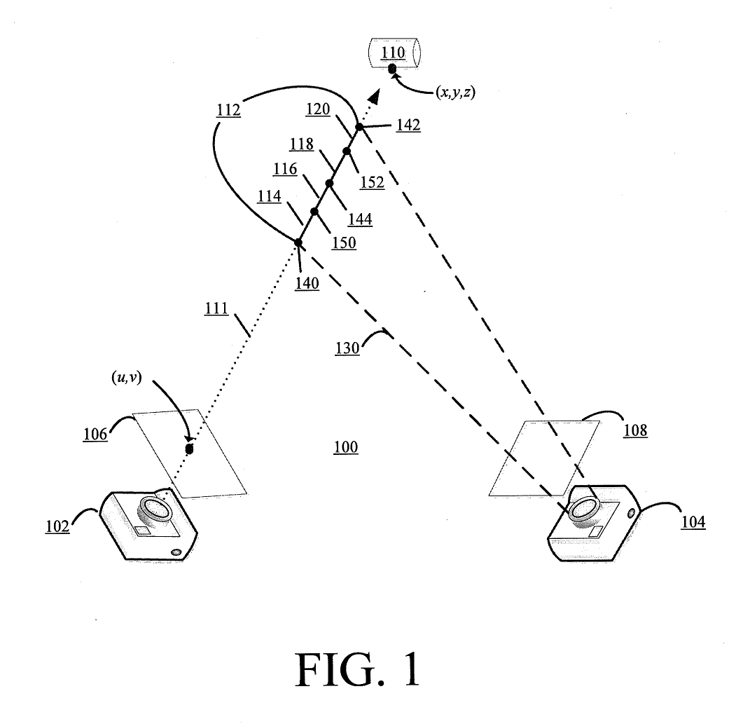

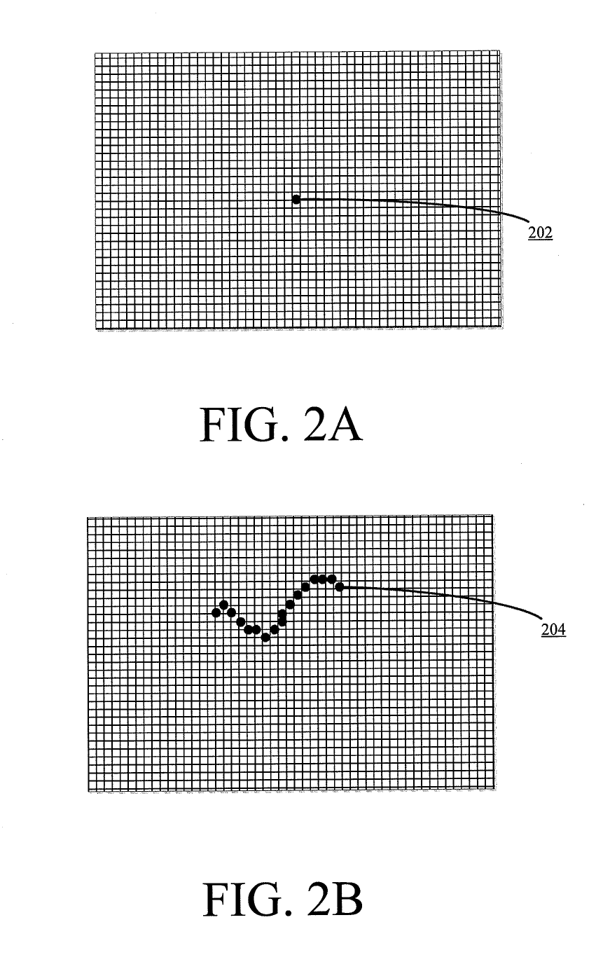

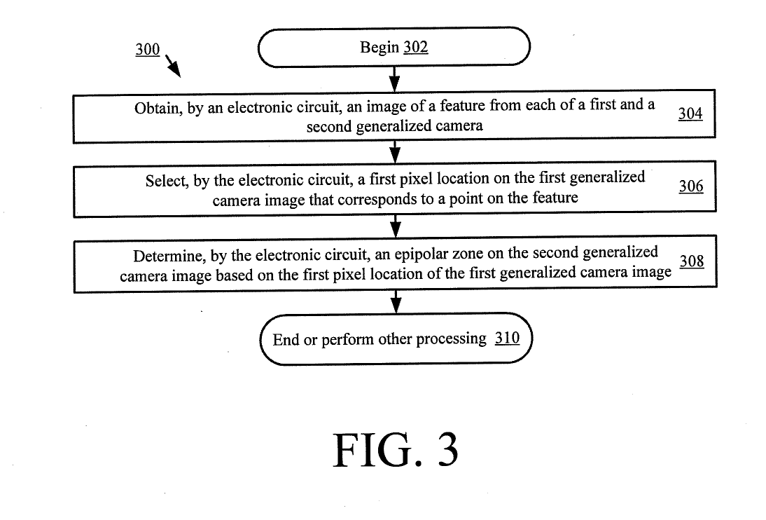

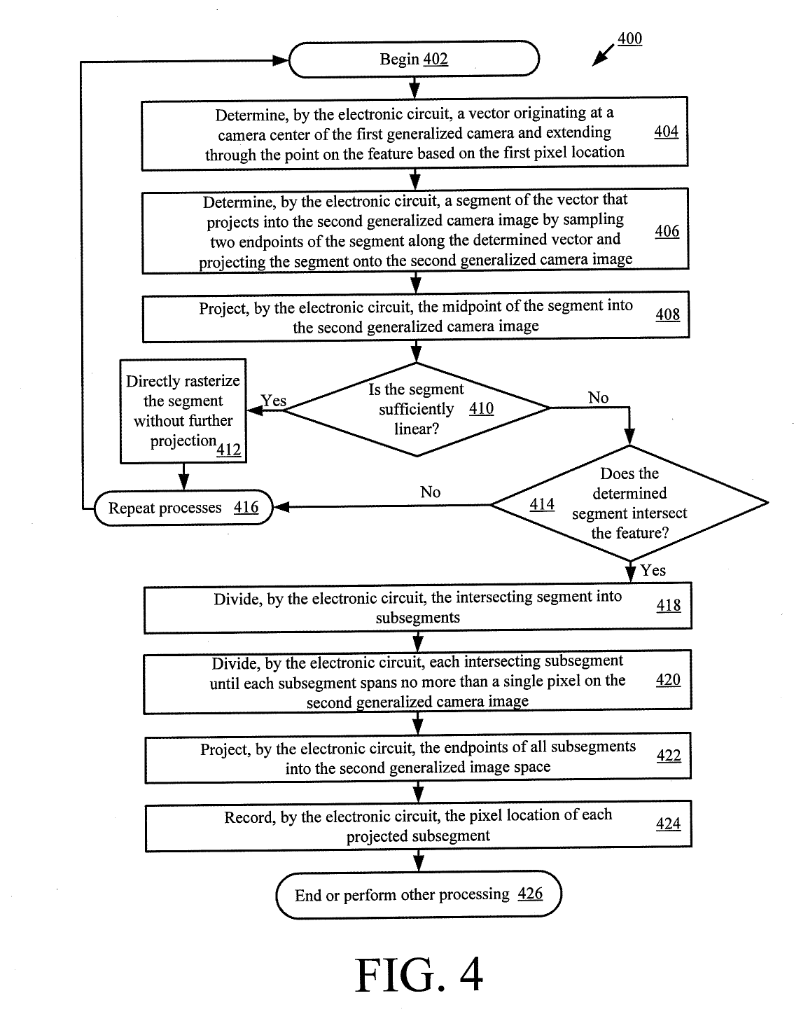

Various implementations may be used in alternative devices and device applications including, but not limited to, mobile phone applications, portable computer applications, and PDA applications. Exemplary implementing system embodiments of the present invention will be described below in relation to FIGS. 1-2B. Exemplary method embodiments of the present invention will be described below in relation to FIGS. 3-4.

### Exemplary Systems

Referring now to FIG. 1, there is provided a block diagram of an exemplary system 100. An exemplary system 100 comprises a generalized source camera 102 and its corresponding image space 106, a generalized target camera 104, and its corresponding image space 108. The system 100 may include more, less, or different components than those illustrated in FIG. 1. However, the components shown are sufficient to disclose an illustrative embodiment implementing the present invention.

The generalized source camera 102 and the generalized target camera 104 view a feature 110 which is projected onto their respective images spaces 106, 108. From the perspective of generalized source camera 102, a single pixel location on image space 106 is referenced as (u,v), where u and v defines a two dimensional coordinate location on image space 106 relative to an arbitrary origin. In an implementation, the origin is the extreme lower left corner of image space 106 and u may refer to the number of pixels to the right of the origin and v may refer to the number of pixels above the origin. In this way, the coordinates (u,v) uniquely describe a single pixel location on the image space 106 of generalized source camera 102.

The pixel location (u,v) may refer to projection of a reference point located on a feature 110. Feature 110 is some three dimensional object occupying Euclidean space. The reference point (u,v) corresponds to a three dimensional point in space (x,y,z) located on feature 110, where x, y, and z correspond to a three dimensional coordinate location in Euclidean space relative to an arbitrary origin. In an implementation, the arbitrary origin is the camera center of the generalized source camera 102 and x, y, and z may refer to the number of distance units that uniquely define a three dimensional point in horizontal distance, vertical distance, and depth distance. In this way, the coordinates (x,y,z) uniquely define a single point, relative to the camera center, that exists in three dimensional Euclidean space.

A ray 111 may be extended from the camera center of the generalized source camera 102 in the direction of and running through point (x,y,z) on feature 110. Alternatively, the ray 111 may be described as a ray emanating from the camera center of generalized source camera 102 and passing through point (u,v) of the projection of feature 110 on image space 106 of camera 102. Therefore, from the perspective of generalized source camera 102, the ray 111 will appear as a point on the projection of feature 110 onto image space 106 at the coordinate location (u,v). This perspective is shown in FIG. 2A which is a representation of image space 106 of generalized source camera 102 and illustrates ray 111 as a point (u,v).

The generalized target camera 104 views the same feature 110 from a different perspective and projects onto its own image space 108. From the perspective of generalized target camera 104, the ray 111 is not represented by a point, but is a line that may be projected onto image space 108, as shown in FIG. 2B. In the specific case of linear cameras, the conversion of Euclidian world coordinates to pixel coordinates through the use of epipolar geometry and is well known to those of ordinary skill in the art. Many non-linear cameras, specifically those that have a single center of projection, may be “linearized” through a mapping function to an approximate linear camera. Epipolar constraints may them be established between the two image spaces. This method does not apply to generalized cameras that do not have a single center of projection, e.g. a rolling shutter camera.

The method provided below in reference to FIG. 3, describes the use of epipolar zones to approximate epipolar constraints that allow for the analysis of feature 110 in the image space 108 of generalized target camera 104. Each generalized camera 102 and 104 implements two pixel projection functions that allow for immediate conversion between a two dimensional pixel location, (u,v) and a three dimensional world point location (x,y,z).

One function converts a known pixel location (u,v) into a ray r(nₓ,n_{y},n_{z}) (i.e., ray 111) through a function

pixel_to_world_ray(C,u,v)→(nₓ,n_{y},n_{z)} (Equation 1)

Where C is a generalized camera model, coordinates u and v identify a pixel location on the camera's image space, and coordinates nₓ, n_{y}, and n_{z} define a unit vector establishing the direction of a ray emanating from pixel location (u,v) into Euclidian space.

Another function converts a three dimensional world point (x,y,z) to a pixel location (u,v):

world_point_to_pixel(C,x,y,z)→(u,v) (Equation 2)

Where C is a generalized camera model, coordinates x, y, and z identify a world point in Euclidian space, and u and v identify a pixel location on the camera's image space.

In both functions, C is a generalized camera model. A generalized camera model as used herein is defined as the two functions that map between locations in the camera image and points in 3D space. This differs from a normal camera model because of the inclusion of time. The projection function maps a 3D point and time (x,y,z,t) to an image location (x,y). The inverse projection function maps an image location and time (x,y,z,t) to an optical center (ox,oy,oz) and a direction (x,y,z) from that optical center. The element of time is introduced because the camera may be in motion, and the shutter—i.e., the rolling shutter—is a function of time. Thus, the center of the camera may be moving as a function of time.

In an implementation, generalized source camera 102 and generalized target camera 104 each generate a two dimensional image of a feature 110 on their respective image spaces 106 and 108. For example, using a function pixel_to_world_ray(C₁,u₁,v₁), a ray 111 is computed emanating from the camera center of generalized source camera 102 and passing through the feature at (u₁,v₁), where C₁ is a generalized camera model of generalized source camera 102. Subsegments of ray 111 are computed by sampling points (xᵢ,yᵢ,zᵢ) along ray 111 to be used as inputs into a function world_point_to_pixel(C₂,xᵢ,y₁,zᵢ), where C₂ is a generalized camera model of generalized target camera 104.

If any non-empty intersections exist between ray 111 and the feature 110, continue dividing subsegments further until each subsegment spans no more than one pixel in the image space 108 of generalized target camera 104. The pixel span may be computed using the world_point_to_pixel function of the sampled points to find the projection of the pixel span's end points on the image space 108 and measuring the distance between them. The endpoints of all subsegments are projected into the image space 108 using the world_point_to_pixel function and the discrete pixel locations of each subsegment are recorded. The collection of pixel locations define an epipolar zone of feature 110 in the image space 108 of generalized target camera 104. The epipolar zone identifies which pixels in the image space 108 contain a view of feature 110.

As noted above, the system 100 implements methods for analyzing images from generalized cameras. Exemplary embodiments of such methods will now be described in relation to FIGS. 3-4.

### Exemplary Methods

Referring now to FIG. 3, there is provided a flow diagram of an exemplary method 300 analyzing images obtained from two generalized cameras. The method 300 is useful in applications, such as mobile phone and smart phone applications, portable computer applications, PDA applications, portable navigation device applications, and any other application in which analysis of generalized camera imagery is desired. Further, the method 300 will be described in reference to an electronic circuit, which may be present in any device capable of running any of the above mentioned applications.

As shown in FIG. 3, the method 300 begins with step 302 and continues with step 304. In step 304, an electronic circuit obtains an image of a feature from each of a first and second generalized camera. The first and second generalized cameras may be any cameras described by a generalized camera model. In one implementation, for example, the first and second cameras are two physical cameras arranged as a single stereo camera for recording of three dimensional images. In another implementation, the first and second cameras may be the same camera recording images at two different times, i.e., a rolling shudder camera. The implementations of the invention are not limited in this regard.

Once step 304 is completed, step 306 is performed where the electronic circuit selects a first pixel location on the first generalized camera image that corresponds to a point on the feature. Referring to FIG. 2A, the pixel location (u,v) represents a point on the feature 110 as projected into the image space 106 of the generalized source camera 102.

Once step 306 is completed, step 308 is performed where the electronic circuit determines an epipolar zone on the second generalized camera image based on the first pixel location of the first generalized camera image. In an implementation, an epipolar zone may be a portion of the image space 108 of the generalized target camera 104 in which may contain a view of feature 110. This information may be used in feature matching between the two image spaces.

Once step 308 is performed, step 310 is performed where method 300 ends or other processing is performed.

Referring now to FIG. 4, there is provided a flow diagram of an exemplary method 400 of determining epipolar zones on an image space based on pixel location data from another image space. The method 400 is useful in applications, such as mobile phone and smart phone applications, portable computer applications, PDA applications, portable navigation device applications, and any other application in which analysis of generalized camera imagery is desired. Further, the method 400 will be described in reference to an electronic circuit, which may be present in any device capable of running any of the above mentioned applications.

As shown in FIG. 4, the method 400 begins with step 402 and continues with step 404. In step 404, an electronic circuit determines a vector originating at a camera center of the first generalized camera and extending through a point on a feature based on the first pixel position. In an implementation, a function pixel_to_world_ray defines a unit vector emanating from the camera center of the generalized source camera 102 and oriented toward a point (x,y,z) in Euclidian space based on an input of the pixel location (u,v) on the image space 106 of the generalized source camera 102. The point (x,y,z) may correspond to a point on a feature that is to be matched with a feature on the image space 108 of generalized target camera 104.

Once step 404 is completed, step 406 is performed where the electronic circuit determines a segment of the vector that projects into the second generalized camera image by sampling two endpoints of the segment along the determined vector and projecting the segment into the second generalized camera image. As shown in FIG. 1, while the ray 111 emanating from the camera center of the generalized source camera 102 appears as a single pixel location on its images space 106 (see FIG. 2A), the ray 111 appears in the image space 108 of generalized target camera 104 as a line. In the case of a purely linear camera, or a non-linear camera having only one center of projection for all pixels in its image space and capable of being approximated by a purely linear camera model, the ray would appear as a straight line. For non-linear generalized cameras here every pixel does not have the same center of projection, the ray's appearance may depend on the camera model used to project the ray onto the image space.

In an implementation, a segment of ray 111 may calculated, segment 112, and projected on to the image space 108 of generalized target camera 104. Referring again to FIG. 1, the segment may calculated by locating two points along ray 111, point 140 and point 142. The two points form the endpoints of a line segment 112. The endpoints 140 and 142 may the be projected onto the image space 108 of generalized target camera 104 and the distance between them may be measured. If the distance between the two end points is more than a single pixel in the image space 108, then the segments may be further divided into subsegments as described below.

In another implementation, the segment 112 may be the determined by the electronic circuit approximating the second generalized camera's field of view and calculating an intersection of the vector with the approximation, wherein the intersection of the vector and the approximation are the two endpoints of the segment. Referring again to FIG. 1, field of view 130 may be approximated to determine what portion of ray 111 is visible in image space 108 of generalized target camera 104. As shown in FIG. 1, ray 111 intersects with approximate field of view 130 at points 140 and 142. Therefore, the segment 112 is the line formed along ray 111 between points 140 and 142.

Referring again to FIG. 4, once step 406 is completed, optional steps 408-412 may be performed where the electronic circuit projects the midpoint of the segment into the second generalized camera image and, if the segment is sufficiently linear relative to the pixel size of the second generalized camera image, directly rasterizes the segment without further projection. In an implementation, referring to FIG. 1, a midpoint 144 of the segment 112 may also be located, and projected onto image space 108. The segment 112, running between points 140-144 may be analyzed to determine whether it is sufficiently linear to allow for direct rasterization of the segment. A segment is sufficiently linear if the segment only deviates from an ideal line only by some predetermined amount. The amount of deviation that is allowed depends on the amount of distortion that is acceptable for the particular application. The implementations of the present invention are not limited in this regard. If the non-linear distortion is below the threshold, e.g. the segment is sufficiently linear, the pixels representing that segment can be rasterized and matched to features from the other image space 106 of the generalized source camera 102 without further projection. Therefore, computation and feature matching speed are increased with minimal effects on the accuracy of the result.

Referring again to FIG. 4, one skilled in the art will note that steps 408-412 are optional, and the method 400 may directly progress to step 416 and 418. In steps 416-418, if the determined segment intersects with the feature, the electronic circuit divides the intersecting segment into subsegments. In an implementation, segment 112 may be divided into subsegments, 114-120. These subsegments may then be projected onto image space 108 of generalized target camera 104.

Once step 418 is completed, step 420 is performed where the electronic circuit further divides each intersecting subsegment until each subsegment spans no more than a single pixel on the second generalized camera image. In an implementation, intersecting the subsegments 114-120 created in step 418 may be analyzed and further divided until each subsegment spans no more than one pixel. The pixel span may be determined by projecting the endpoints of the subegments onto the image space 108 of generalized target camera 104 and measuring the distance between them. For example, subsegment 114 is defined by endpoints 140 and 150. These points may be projected onto image space 108. If the distance between them is less than a single pixel, i.e. they are projected onto the same pixel of image space 108, the span of the subsegment 114 is less than a single pixel.

Once step 420 is completed, step 422 is performed where the electronic circuit projects all endpoints of all subsegments onto the second generalized image space. The method 400 continues with step 424 where the electronic circuit records the pixel location of each projected subsegment. In an implementation, the endpoints of all intersecting subsegments are projected into the image space 108 of generalized target camera 104, as shown in FIG. 2B as epipolar zones 204. These epipolar zones indicate a feature match for the point 202, shown in FIG. 2A in other generalized camera's image space.

In an implementation, the processing time of the epipolar zones may be decreased by scaling the pixel size of the image space 108 at the expense of accuracy. As noted previously, the requirements of the application of method 400 may change depending on the desired accuracy. In another implementation, any processing step introduces inaccuracies in the calculation of the epipolar zones, the final result of method 400 may be dilated such that the enlarged zone includes the true epipolar zone. This increases computational speed but produces larger zones to be consumed by downstream processing.

The method 400 continues with step 426 where method 400 ends or other processing is performed.

In various implementations, the methods described above may be implemented in systems and devices which include non-transient computer-readable media. Such systems may include at least one electronic circuit configured to perform the methods described above. Devices which include non-transient computer readable media may also include computer programs having a number of code sections. These code sections may be executable by a computer to cause the computer to perform the methods described above.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

1. A method for calculating epipolar constraints between a plurality of generalized cameras by a device that comprises an electronic circuit, the method comprising:
obtaining, by the electronic circuit, an image of a feature from each of a first and a second generalized camera;
selecting, by the electronic circuit, a first pixel location on the first generalized camera image that corresponds to a point on the feature;
determining, by the electronic circuit, a vector originating at a camera center of the first generalized camera and extending through the point on the feature based on the first pixel location;
determining, by the electronic circuit, a segment of the vector that projects into the second generalized camera image by sampling two endpoints of the segment along the determined vector and projecting the segment onto the second generalized camera image; and
determining, by the electronic circuit, an epipolar zone on the second generalized camera image based on the first pixel location of the first generalized camera image and the segment of the vector that projects into the second generalized camera image.

2. The method according to claim 1, wherein the first and second generalized camera images are produced by rolling shutter cameras.

3. The method according to claim 1, wherein the first and second generalized camera images are produced by the same physical camera at different times.

4. (canceled)

5. The method according to claim 1, wherein the determining the segment further comprises:
approximating, by the electronic circuit, the second generalized camera's field of view; and,
calculating, by the electronic circuit, an intersection of the vector with the approximation, wherein the intersection of the vector and the approximation are the two endpoints of the segment.

6. The method according to claim 1, further comprising:
projecting, by the electronic circuit, the midpoint of the segment; and,
on a condition that the segment is sufficiently linear, relative to a pixel size of the second generalized camera image, directly rasterizing the segment without further projection.

7. The method according to claim 1, further comprising:
on a condition that the determined segment intersects with the feature, dividing, by the electronic circuit, the intersecting segment into subsegments.

8. The method according to claim 7, further comprising:
further dividing, by the electronic circuit, each intersecting subsegment until each subsegment spans no more than a single pixel on the second generalized camera image.

9. The method according to claim 8, further comprising:
determining, by the electronic circuit, a plurality of epipolar zones by:
projecting the endpoints of all subsegments into the second generalized camera image; and,
recording the pixel location of each projected subsegment.

10. The method according to claim 6, further comprising:
adjusting, by the electronic circuit, a pixel size of the second generalized camera image.

11. The method according to claim 10, wherein the adjusting increases the pixel size of the second generalized camera image and increases the processing rate.

12. A system comprising:
at least one generalized camera recording a plurality of images of a feature; and,
a device comprising an electronic circuit configured to:
obtain a first and second generalized camera image from the at least one generalized camera;
select a first pixel location on the first generalized camera image that corresponds to a point on the feature;
determine a vector originating at a camera center of the first generalized camera and extending through the point on the feature based on the first pixel location;
determine a segment of the vector that projects into the second generalized camera image by sampling two endpoints of the segment along the determined vector and projecting the segment onto the second generalized camera image; and
determine an epipolar zone on the second generalized camera image based on the first pixel location of the first generalized camera image and the segment projected onto the second generalized camera image.

13. (canceled)

14. The system according to claim 12, wherein the electronic circuit is further configured to:
approximate the second generalized camera's field of view; and,
calculate an intersection of the vector with the approximation, wherein the intersection of the vector and the approximation are the two endpoints of the segment.

15. The system according to claim 12, wherein the electronic circuit is further configured to:
project a midpoint of the segment; and,
on a condition that the segment is sufficiently linear relative to a pixel size of the second generalized camera image, directly rasterize the segment without further projection.

16. A non-transitory computer-readable storage medium having stored thereon a computer program for analyzing road quality information, the computer program having a plurality of code sections, the code sections executable by a computer to cause the computer to perform the steps of:
obtaining, by an electronic circuit, an image of a feature from each of a first and a second generalized camera;
selecting, by the electronic circuit, a first pixel location on the first generalized camera image that corresponds to a point on the feature;
determining, by the electronic circuit, a vector originating at a camera center of the first generalized camera and extending through the point on the feature based on the first pixel location;
determining, by the electronic circuit, a segment of the vector that projects into the second generalized camera image by sampling two endpoints of the segment along the determined vector and projecting the segment onto the second generalized camera image; and
determining, by the electronic circuit, an epipolar zone on the second generalized camera image based on the first pixel location of the first generalized camera image and the segment projected onto the second generalized camera image.

17. (canceled)

18. The storage medium according to claim 16 further comprising code sections for causing the computer to perform the steps of:
approximating, by the electronic circuit, the second generalized camera's field of view; and,
calculating, by the electronic circuit, an intersection of the vector with the approximation, wherein the intersection of the vector and the approximation are the two endpoints of the segment.

19. The storage medium according to claim 16 further comprising code sections for causing the computer to perform the steps of:
on a condition that the determined segment intersects with the feature, dividing, by the electronic circuit, the intersecting segment into subsegments.

20. The storage medium according to claim 19 further comprising code sections for causing the computer to perform the steps of:
determining, by the electronic circuit, a plurality of epipolar zones by:
projecting the endpoints of all subsegments into the second generalized camera image; and,
recording the pixel location of each projected subsegment.
